(19) United States
(12) Patent Application Publication
(10) Pub. No.: US 2009/0102189 A1
(43) Pub. Date: Apr. 23, 2009

(54) Jacketed self cooling high pressure rotary swivel

(76) Inventors: Douglas E. Wright, Durango, CO (US); Gerald P. Zink, Durango, CO (US)

Correspondence Address: Kenton L. Freudenberg, P.O. Box 841, Durango, CO, 81302, US

(21) Appl. No.: 11/975,429

(22) Filed: Oct. 19, 2007

(51) Int. Cl. F16L 27/00

(52) U.S. Cl. 285/272

(57) ABSTRACT

A high pressure rotary swivel assembly for use in high temperature environments using a single source of fluid for operation and cooling, having an external sleeve to accommodate a low volume and/or low pressure fluid cooling circuit having a path over the majority of the external surface of the swivel body to absorb ambient heat, where the cooling circuit is fed by redirecting a small portion of the high pressure and high volume operating fluid.

### BACKGROUND OF THE INVENTION

The present invention provides a high-pressure rotating swivel having an external cooling jacket fed by a portion of the operating fluid to allow use in high temperature environments.

### SUMMARY OF THE INVENTION

Rotating waterjet nozzles for use in a high pressure (HP) range of approximately 1,000 to 40,000 psi and high fluid flow rates have become common maintenance tools used for cleaning, descaling or removing slag from industrial components such as furnaces, boilers and/or cookers. In order that maintenance can be done the most economical and efficient manner possible it is desirable to minimize the time in which any such equipment is not operational or is “offline.” Since such devices typically operate at high temperatures, significant time may be involved in allowing a device to cool to a suitable ambient temperature. Accordingly, it can be desirable to perform cleaning or maintenance while such devices are at or near operating temperature, or even during operation.

Fixed nozzles and lances are readily made entirely from metallic materials such as stainless steel which are suitable for use in high temperature environments but lack the benefit of a rotating nozzle to provide pattern of complete coverage of the surface being cleaned. The construction of a high pressure rotary swivel to provide a high pressure rotary waterjet nozzle has typically involved use of components which are not tolerant of operation at high temperatures. Such components such as shown in U.S. Pat. No. 6,059,202 to Zink, et al can include seals made from durable plastic, rubber or other similar materials which may be degraded or lose their beneficial physical properties when subjected to excessive heat. Other heat intolerant components can include lubricants, and viscous fluids which may be used for purposes such as speed control as shown in U.S. Pat. No. 5,964,414 to Hardy et al.

It is also well recognized that many of the high heat areas which are cleaned using waterjet tools, i.e. boiler tubes, are of small diameter or are accessed through passages of small diameter thereby requiring that the waterjet tools being used also be of small diameter. It is therefore desirable to minimize the thickness of any space or component which may add to the overall diameter of the tool.

Accordingly, in order to achieve the benefit of a high-pressure rotary swivel for use in a high temperature environment, the present invention provides for redirecting a small portion of the high pressure water or operating fluid into a space between the main body and thin-walled external jacket where it circulates at low pressure to absorb and dissipate heat thereby preventing overheating of the components of the swivel.

It is an object of the present invention to provide a high-pressure rotary waterjet nozzle or swivel assembly capable of operating in a high temperature environment.

It is another object of the present invention to provide a high-pressure rotary waterjet nozzle or swivel assembly capable of high temperature operation which is cooled using only the operating fluid.

It is another object of the present invention to provide a high-pressure rotary waterjet nozzle or swivel assembly capable of high temperature operation having a cooling circuit separate from the operating circuit, but using only a single source of fluid for both circuits.

It is another object of the present invention to provide a high-pressure rotary waterjet nozzle or swivel assembly capable of high temperature operation with a low pressure cooling circuit fed by the high-pressure operating fluid.

It is another object of the present invention to provide a high-pressure rotary waterjet nozzle or swivel assembly capable of high temperature operation with a low volume cooling circuit fed by the high-pressure operating fluid.

It is another object of the present invention to provide a high-pressure rotary waterjet nozzle or swivel assembly capable of operating in a high temperature environment where the body of the swivel is of small diameter.

It is an object of the present invention to provide for simple manufacture of a high-pressure rotary waterjet nozzle or swivel assembly capable of operating in a high temperature environment.

### DESCRIPTION OF THE DRAWINGS

FIG. 1 is a cross-section along the axis of the swivel of the preferred embodiment.

FIG. 2 is an exploded view of the swivel of the preferred embodiment showing the components of the swivel.

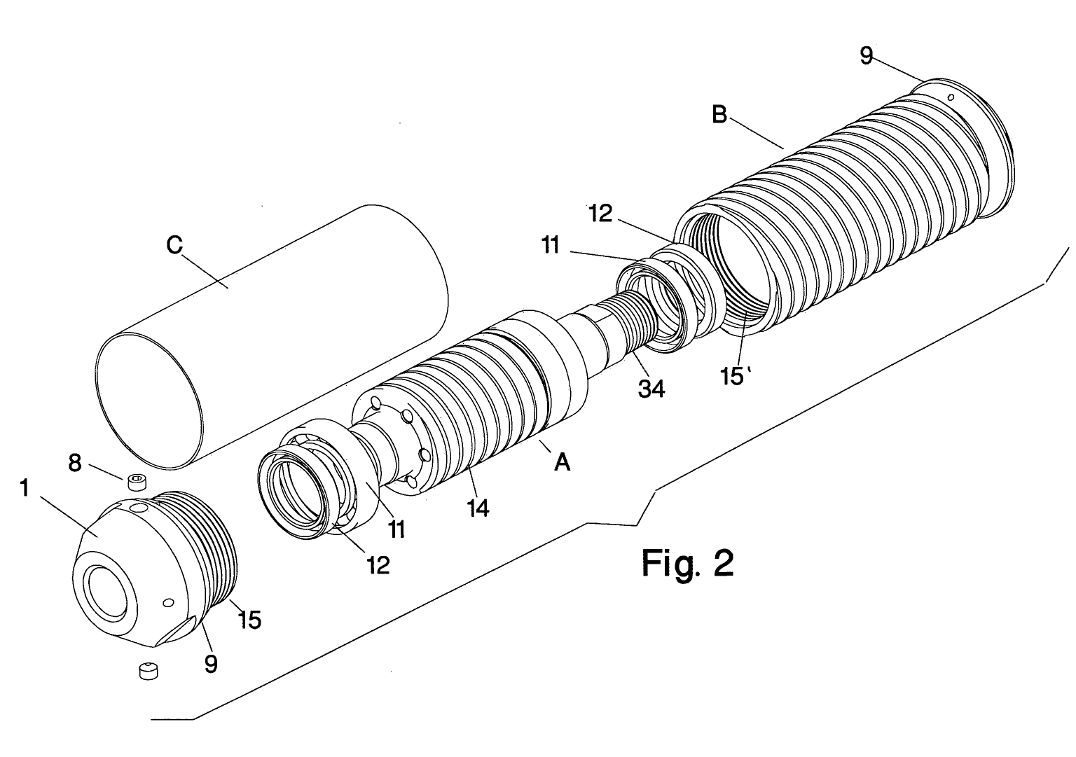

FIG. 3 is a cutaway perspective view of the swivel of the preferred embodiment showing the swivel assembly.

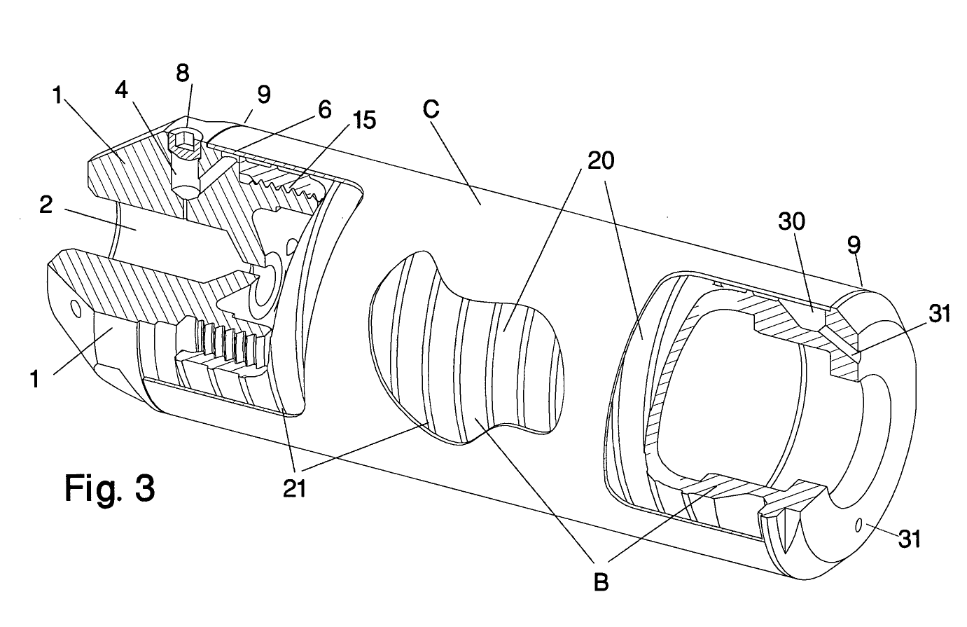

### DETAILED DESCRIPTION OF THE INVENTION

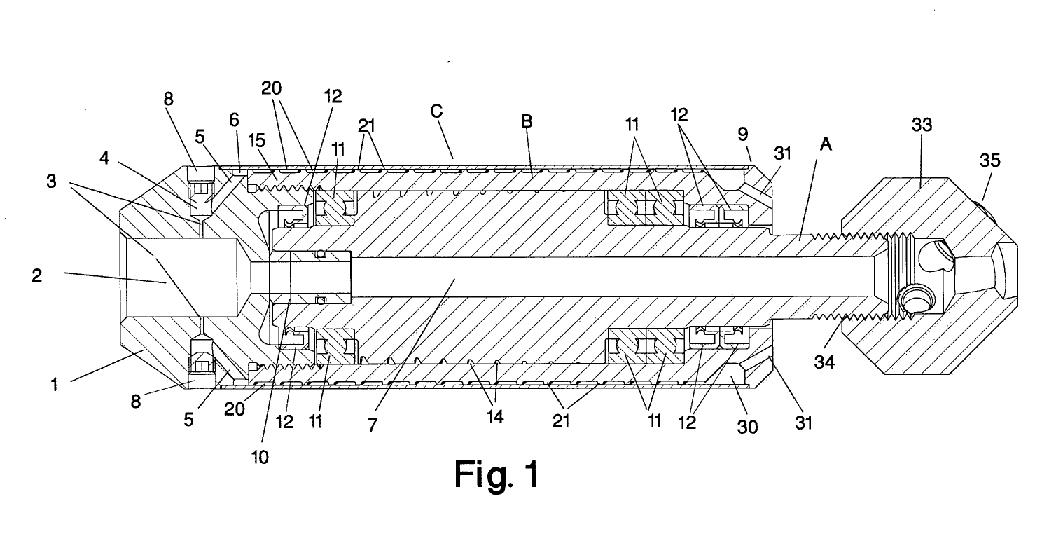

As can be seen most clearly in FIG. 1 the cooled rotary nozzle assembly of the present invention is comprised of three primary components, a main body B, a rotary shaft A and an external sleeve C. Each of these primary components is constructed from any suitable material, typically a stainless steel.

It is to be understood that the invention described herein relates to the novel construction of an external cooling sleeve in conjunction with the main body and that the configuration of the rotary shaft with respect to the main body as described herein is merely representative. The present invention is readily adaptable to virtually any configuration of shaft and main body which might be chosen. In order to facilitate economical manufacturing of the cooling jacket structure, the required machining operations are largely limited to the exterior of the main body.

As described and illustrated herein the preferred embodiment is directed to cooling a swivel assembly in which the rotary shaft B is provided with a tapering spiral groove 14 and turns in a bath of a viscous lubricating fluid for speed control as shown in U.S. Pat. No. 5,964,414 to Hardy et al, which is incorporated herein by reference. Seals 12 at each end of the shaft retain the fluid and lubricant and prevent intrusion of contaminants.

For the intended high-temperature use of the present invention, a swivel assembly is typically attached using threaded connection or other suitable means to the end of a hollow tubular metallic lance or hose to provide a flow of high-pressure fluid into the inlet chamber 2 of the inlet nut 1 of the main body B. From chamber 2 the primary flow of operating fluid continues axially into and through the central bore 7 of the rotating shaft to the nozzle end 32 of the shaft were the fluid exits through a nozzle 33 fixed to the shaft end using a threaded connection 34. The characteristics of the nozzle are determined by configuration of nozzle exit ports 35 chosen to provide appropriate self-rotation of the nozzle, a desired fluid volume and velocity and an appropriate cleaning pattern. The shaft is supported on bearings 11 suitable to allow rotation of the shaft relative to the body and the interface between the shaft and body is provided with a suitable high pressure rotary seal 10 to allow retention of the operating pressure of the swivel.

Inlet chamber 2 is further provided with one or more restrictive “bleed” passages or inlet orifices 3 to allow redirecting a small portion of the fluid through a passage or chamber 4 and 5 to an annular chamber 6 formed between the external sleeve C, and a circumferential recess machined on the outside of the main body. Fluid enters chamber 4 at relatively high velocity where its velocity is dissipated by being directed at a removable and replaceable plug 8 threaded into the main body.

As an example, when the total fluid flow passing through the swivel assembly may be about 60 gallons per minute, the flow diverted through by the bleed orifice(s) may be only about 1 to 2 gallons per minute. Additionally, the restrictive nature of the bleed orifices causes a pressure drop in the fluid from a many thousands of pounds per square inch (psi) to perhaps 100 psi, thereby allowing the external sleeve to be constructed using a relatively thin wall. The bleed orifice 3 and chamber 3 are readily created constructed by simply drilling holes of appropriate diameter from the outside of the main body. Each bleed orifice could also be made replaceable by being incorporated into a “thread-in” assembly in lieu of the separate plug 8 and orifice 3.

Annular chamber 6 communicates with one or more substantially circumferential spiral or helical passages 20 defined by grooves or channels machined on the outside of the main body to evenly and fully cover the outer surface area of the main body B. The outer diameter of the main body B is precisely “press fit” within the inner diameter of external sleeve C so that spiral passages 20 are defined between the lands 21 of the spiral grooves, the outside of the main body and the inside of the external sleeve C. External sleeve C is further secured in place and sufficiently sealed by its opposite ends being seated against lips 9 of the main body. The inlet nut 1 of the main body is threaded into the main body with mating threads 15 and 15′ which secure the entire assembly together. Flow of operating fluid through these passages provides heat transfer to conduct the high ambient heat of the operating environment away from the components of the swivel. For reasons discussed above it may be desirable to limit the wall thickness of the external sleeve. However since the sleeve is evenly and fully supported by the external lands 21 of the main body, the durability of the sleeve is not significantly compromised by use of a thin-walled structure. While a spiral configuration of the passages is easily machined and is well suited to providing support of the external sleeve and controlled heat dissipation over substantially the entire surface of the main body, any configuration of a fluid pathway between the main body and external sleeve may be chosen so as to maximize any such characteristics which may be desirable.

Each spiral passage conducts a flow of operating fluid toward the outlet end of the assembly where each such passage communicates with another annular chamber 30 which, in turn, communicates with one or more exhaust ports 31 to allow the operating fluid from the cooling circuit to exit the swivel as waste. Since the volume of fluid flow through the cooling circuit is largely defined by restrictive nature of the inlet orifices, the exhaust ports need not be restrictive. However, as alternative configurations, the exhaust ports may be of a restrictive nature to either control flow through the cooling circuit or to allow the cooling circuit to be operated at high pressure with the exhaust ports providing additional fixed waterjets.

What is claimed is:

1. A high pressure rotary swivel assembly for use in high temperature environments wherein said swivel assembly comprises a generally cylindrical housing, said housing having an outer surface defined by a thin walled member,
said swivel including a high pressure fluid circuit for the operating fluid, and a low pressure cooling circuit,
wherein the low pressure cooling circuit includes at least one restrictive inlet passage from the high pressure circuit to direct a portion of the high pressure operating fluid into said low pressure circuit, said low pressure circuit further comprising a passage encompassing a continuous pathway within said thin walled member and in close proximity to the exterior of said swivel housing,
said low pressure circuit further comprising an outlet port to discharge said low pressure cooling fluid to the exterior of said swivel assembly.

2. A high pressure rotary swivel assembly according to claim 1 wherein said low pressure circuit comprises one or more generally circumferential passages in a helical pattern within said thin walled member.

3. A high pressure rotary swivel assembly according to claim 1 wherein said low pressure circuit is disposed beneath the majority of the surface area of said thin walled member.

4. A high pressure rotary swivel assembly according to claim 1 wherein said outlet port of said low pressure circuit is configured to provide directional waterjet ports.

5. A high pressure rotary swivel assembly according to claim 1 wherein said the volume of flow redirected through the low pressure circuit is approximately 1-2% of the flow through the high pressure assembly.

6. A high pressure rotary swivel assembly for use in environments of high ambient temperature, comprising a generally cylindrical main body containing a high pressure circuit for the operating fluid, an external sleeve surrounding said main body, a low pressure circuit to conduct ambient heat away from said body formed between said main body and said external sleeve, said low pressure circuit being supplied with low pressure cooling fluid fed to said cooling circuit from said high pressure circuit through a restrictive port.

7. A high pressure rotary swivel assembly according to claim 6 wherein said external sleeve is a thin walled cylindrical tube fitting tightly over said main body and said low pressure circuit is comprised of passages defined between said sleeve and one or more channels machined into the surface of said main body.

8. A high pressure rotary swivel assembly according to claim 6 wherein each said channels is of a generally helical configuration.

9. A high pressure rotary swivel assembly for use in environments of high ambient temperature, wherein a single source of fluid is used internally as both high pressure operating fluid and low pressure cooling fluid, the low pressure cooling fluid being directed into contact with the outer shell of the device to absorb and dissipate ambient heat and be discharged to the exterior of the assembly.
